(19) United States
(12) Patent Application Publication
(10) Pub. No.: US 2007/0150584 A1
(43) Pub. Date: Jun. 28, 2007

(54) Apparatus, system, and method for determining server utilization in hosted computing infrastructure

(76) Inventor: Deepa Srinivasan, Cary, NC (US)

Correspondence Address: KUNZLER & ASSOCIATES, 8 EAST BROADWAY, SUITE 600, SALT LAKE CITY, UT, 84111, US

(21) Appl. No.: 11/319,858

(22) Filed: Dec. 28, 2005

(51) Int. Cl. G06F 15/173

(52) U.S. Cl. 709/224

(57) ABSTRACT

An apparatus, system, and method are disclosed for determining server utilization in a hosted computing resources infrastructure/environment. A monitor module intercepts a packet communicated between a client and a server. An extraction module extracts a service indicator from the packet. In a certain embodiment, an identification module identifies the client from the packet. An estimation module estimates a server utilization based on the service indicator. In one embodiment, a billing module calculates a charge for the server utilization.

### BACKGROUND OF THE INVENTION

1. Field of the Invention

This invention relates to determining server utilization and more particularly relates to determining server utilization from intercepted packets.

2. Description of the Related Art

Utility computing allows a client device to use a one or more data processing devices to process data. Typically, the delivery model is over a private or public network. The client device may be a terminal, a computer workstation, a cellular telephone, a laptop computer, a personal digital assistant, and is referred to herein as a client. The data processing device may be a mainframe computer, a server, a computational engine, a computer workstation, and the like, herein referred to as a server.

Typically, the server provider allows the client to access the server for a fee. The client communicates a request to the server. The request may direct the server to perform one or more computational tasks such as accessing a database, performing a finite element analysis, solving a linear programming equation, or the like. The server performs the computational task in response to the request and communicates results from the task to the client. The communicated results may include an acknowledgment that the task is complete, an error message, processed data, retrieved data from a database, or the like.

One or more servers may at various times perform computational tasks for the client, including servers distributed across a plurality of data centers. One or more servers may also cooperate in performing a computational task. In addition, one or more clients may request that a specified server perform computational tasks.

Unfortunately, tracking the services provided by each server for each client adds additional computational and maintenance overhead tasks for the servers. In addition, collecting and collating the service data from a plurality of servers further adds to the overhead burden of the servers. Individual servers may also inaccurately report services provided when tasks are allocated among a plurality of servers.

From the foregoing discussion, it should be apparent that a need exists for an apparatus, system, and method that efficiently determine server utilization. Beneficially, such an apparatus, system, and method would determine server utilization without adding to the overhead burden of servers.

### SUMMARY OF THE INVENTION

The present invention has been developed in response to the present state of the art, and in particular, in response to the problems and needs in the art that have not yet been fully solved by currently available server utilization determination methods. Accordingly, the present invention has been developed to provide an apparatus, system, and method for determining server utilization that overcome many or all of the above-discussed shortcomings in the art.

The apparatus to determine server utilization is provided with a plurality of modules configured to functionally execute the steps of intercepting a packet, extracting a service indicator, and estimating a server utilization. These modules in the described embodiments include a monitor module, an extraction module, and an estimation module.

The monitor module intercepts a packet communicated between a client and a server. The interception does not affect communications between the client and the server. In addition, the monitor module may intercept packets associated with a plurality of servers and/or a plurality of clients. The packet includes a service indicator. The service indicator may be a request from the client for the server to perform a service. Alternatively, the service indicator may be a response from the server indicating that the status of a requested service including that the server performed the requested service.

The extraction module extracts the service indicator from the packet. In one embodiment, the service indicator is a simple object access protocol (“SOAP”) method request such as is defined by the World Wide Web Consortium of Sophia-Antipolis Cedex, France. In an alternate embodiment, the service indicator may be an extensible markup language (“XML”) service request name such as is defined by the World Wide Web Consortium.

In one embodiment, the apparatus also includes an identification module. The identification module identifies the client from the packet. In a certain embodiment, the identification module identifies the client from an address of the packet.

The estimation module estimates a server utilization based on the service indicator. In one embodiment, the estimation module uses the service indicator as a key to select a server utilization estimate from a table. In addition, the estimation module may perform one or more calculations to estimate the server utilization. The apparatus determines the server utilization for one or more servers and one or more clients without adding an overhead burden to the servers.

A system of the present invention is also presented to determine server utilization. The system may be embodied in a data processing system. In particular, the system, in one embodiment, includes a client, a server, a network, a network monitor, and a host.

The network transmits communications between the server and the client. The communications are configured as data packets. The client may communicate a request to the server using a SOAP format, an XML format, or the like. The request includes a service indicator. The server may provide services for the client in response to the request from the client. In one embodiment, the server communicates a response to the client, the response embodied in a packet. The packet includes a service indicator. In addition, the packet may include processed data, retrieved data, or the like.

The network monitor is in communication with the network and includes a monitor module, and an extraction module. In one embodiment, the monitor module monitors communications between the client and the server. The monitor module further intercepts a packet communicated between the client and the server. The extraction module extracts the service indicator from the packet. The network monitor may also include an identification module that identifies the client from the packet. In addition, the network monitor may include a communications module that communicates the service indicator to the host.

The host may be a computer workstation, a server, or the like. In addition, the host may communicate with the network monitor through a dedicated data bus, a point-to-point link, a network, or the like. In one embodiment, the host mounts the network monitor as a daughter card. The communications module may communicate the service indicator to the host. The host includes an estimation module. The estimation module estimates a server utilization based on the service indicator. In one embodiment, the host includes a billing module. The billing module may calculate a charge for the server utilization. In addition, the billing module may aggregate a plurality of charges for the client. The system determines server utilization for the client, and may calculate a charge for the server utilization.

A method of the present invention is also presented for determining server utilization. The method in the disclosed embodiments substantially includes the steps to carry out the functions presented above with respect to the operation of the described apparatus and system. In one embodiment, the method includes intercepting a packet, extracting a service indicator, and estimating a server utilization.

In one embodiment, a monitor module monitors communications between a client and a server. The monitor module intercepts a packet communicated between the client and the server. An extraction module extracts a service indicator from the packet. In one embodiment, an identification module identifies the client from the packet. An estimation module estimates a server utilization from previously configured hosted services data, based on the service indicator. In one embodiment, a billing module calculates a charge for the server utilization.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention determines a server utilization by intercepting communications between a client and the server. In addition, the embodiment of the present invention determines the server utilization without affecting communications between the client and the server, and without imposing an overhead burden on the server. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data processing system in accordance with the present invention;

FIG. 2 is a schematic block diagram illustrating one embodiment of a network monitor and host system of the present invention;

FIG. 3 is a schematic block diagram illustrating one embodiment of a server utilization apparatus of the present invention;

FIG. 4 is a schematic block diagram illustrating one embodiment of a network monitor of the present invention;

FIG. 5 is a schematic flow chart diagram illustrating one embodiment of a server utilization determination method of the present invention;

FIG. 6 is a schematic flow chart diagram illustrating one embodiment of a response identification method of the present invention;

FIG. 7A is a schematic block diagram illustrating one embodiment of a server utilization table of the present invention; and

FIG. 7B is a schematic block diagram illustrating one embodiment of server utilization table entries of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

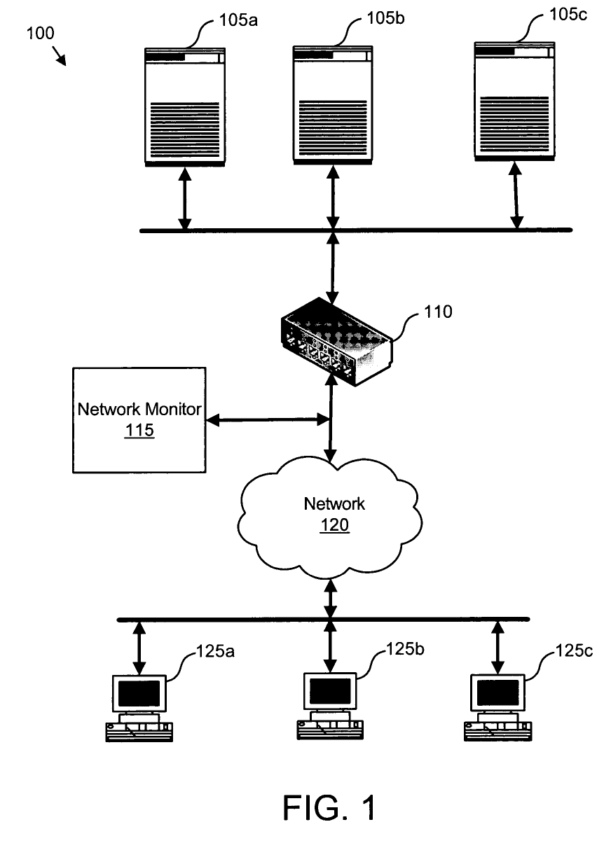

FIG. 1 is a schematic block diagram illustrating one embodiment of a data processing system 100 in accordance with the present invention. The system 100 includes one or more servers 105, a router 110, a network monitor 115, a network 120, and one or more clients 125. Although for simplicity the system 100 is depicted with three servers 105, one router 110, one network monitor 115, one network 120, and three clients 125, any number of servers 105, routers 110, network monitors 115, networks 120, and clients 125 may be employed. In addition, any number of other devices including bridges, storage subsystems, storage devices, and the like, may be employed.

The network 120 transmits communications between the server 105 and the client 125. The network 120 maybe the Internet, a wide area network, a local area network, a token right network, an Ethernet network, or the like. In one embodiment, communications between the server 105 and the client 125 are channeled through the router 110. Alternatively, the communications may be channeled through a plurality of routers 110.

The communications between the server 105 and the client 125 are configured as data packets. Each packet may include an address of a source of the packet, an address of a destination of the packet, counters such as a time-to-live counter that indicates when a packet is lost and should be deleted, instructions, error correction codes, and data.

The packet includes a service indicator. The service indicator may be a request such as a request from the client 125 for the server 105 to perform a task. Alternatively, the service indicator may be a response from the server 105 indicating the status of the requested task including that the server 105 performed the requested task. The service indicator is indicative of a service that is performed by the server 105 for the client

In one embodiment, the request and/or response packets are encoded using an XML protocol format. The XML format describes data that is communicated in a message that may comprise one or more packets as is well known to those skilled in the art. The XML format is platform independent. In addition, the XML message is formatted using tags that describe the data of the message.

In an alternate embodiment, the request and/or response packets are encoded using a SOAP protocol format. The SOAP format uses the XML format as is well known to those skilled in the art. Remote procedure calls may be encoded using the SOAP format. Thus the client 125 may execute a remote procedure call on the server 105 by communicating a packet with a SOAP format request to the server 105.

The server 105 may provide services for the client 125 in response to the request from the client 125. The service may be a database transaction, the execution of a software program, a data search, retrieving a selection from a database, or the like. The server 105 may communicate the response to the client 125. The response may be encoded using an XML format, a SOAP format, and the like. In one embodiment, the response includes processed data delimited by tags such as XML tags. The response may also include a status code delimited by tags. The status code may indicate that a service is successfully provided, that request data is retrieved, and the like.

The service indicator may be an XML service request name. For example, Table 1 illustrates one embodiment of an XML search function. The function includes the XML service request name “query” as shown in the table with “query” emphasized.

TABLE 1

function search( )
{
var parser=new Object(“api.xmldom”)
parser.async=“false”
parser.load(“xml_send.asp?query=” + query.value)
nodes = parser.documentElem.cNodes
answer_text.innerHTML=nodes.item(0).text
answer_xml.value=parser.xml
}

The service indicator may also be a SOAP request. Table 2 illustrates one embodiment of a SOAP service. The SOAP request is emphasized for ease of identification. As illustrated, the SOAP request specifies a function such as a function that maybe executed by the server 105.

TABLE 2
<service name=“ServerService”>

<port name=“ServerPort” binding=“tns:ServerSoap”>

<soap:address location=“mailto:subscribe@example.com”/>

</port>

</service>

The network monitor 115 is in communication with the network 120. In addition, the network monitor 115 may monitor communications between the client 125 and the server 105. Yet, the network monitor 115 does not affect communications between the client 125 and the server 105. The operation of the network monitor 115 is transparent to both the client 125 and the server 105. Thus the network monitor 115 may determine server utilization for one or more clients 125 without added overhead to the clients 125 and/or the servers 105.

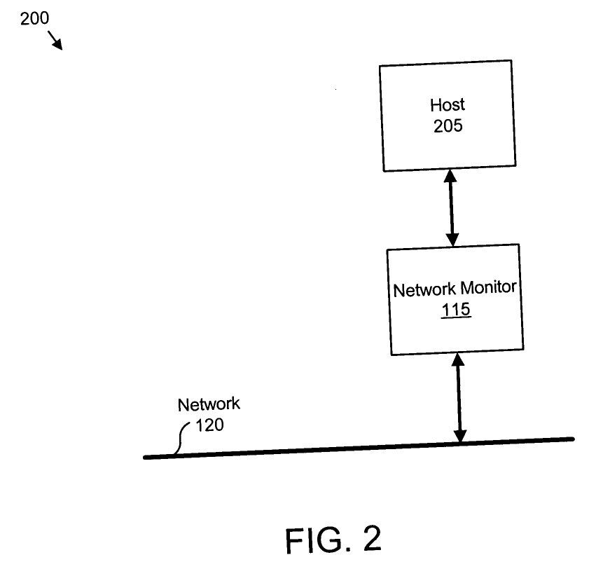

FIG. 2 is a schematic block diagram illustrating one embodiment of a network monitor and host system 200 of the present invention. A network monitor 115 and network 120 may be the network monitor 115 and network 120 of FIG. 1. The system 200 further includes a host 205 in communication with the network monitor 115. The description of the system 200 refers to elements of FIG. 1, like numbers referring to like elements.

The host 205 may be a computer workstation, a server, or the like. In one internal data bus, a point-to-point serial connection such as a universal serial bus (“USB”) connection, a network such as the network 120 of FIGS. 1 and 2, or the like.

In one embodiment, the network monitor 115 is configured as a printed circuit board that mounts within the host 205. The network monitor 115 may communicate through a peripheral component interconnect (“PCI”) connector to a PCI bus of the host 205 as is well known to those skilled in the art. The network monitor 115 may further include a connector such as an Ethernet connector for connecting to the network 120.

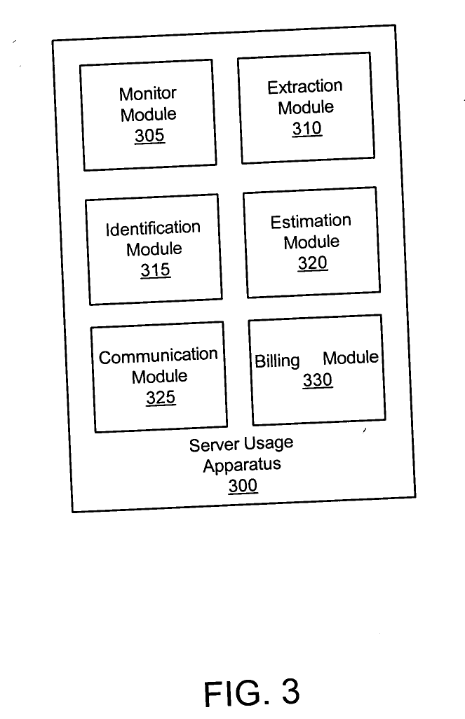

FIG. 3 is a schematic block diagram illustrating one embodiment of a server utilization apparatus 300 of the present invention. The apparatus 300 includes a monitor module 305, extraction module 310, identification module 315, estimation module 320, communication module 325, and billing module 330. The monitor module 305, extraction module 310, identification module 315, estimation module 320, communication module 325, and billing module 330 may be embodied by the network monitor 115 and/or the host 205 of FIG. 2. The description of the apparatus 300 refers to elements of FIGS. 1 and 2, like numbers referring to like elements.

In one embodiment, the monitor module 305 monitors communications between the client 125 and the server 105. For example, the monitor module 305 may read a source and a destination address for each packet communicated over the network 120. In addition, the monitor module 305 intercepts a packet communicated between the client 125 and the server 105. In one embodiment, the monitor module 305 copies the packet to a memory as the packet is communicated over the network 120 as will be described hereafter. The interception of the packet does not affect client/server communications.

The extraction module 310 extracts the service indicator from the packet. For example, the extraction module 310 may parse the packet to locate a context common to service indicators and identify the service indicator from the context. In one embodiment, the identification module 315 identifies the client 125 from the packet. For example, the identification module 315 may identify the client from the source address and/or the destination address of the packet.

In one embodiment, the communication module 325 communicates the service indicator to the host 205. The estimation module 320 may reside in the host 205. In addition, the estimation module 205 estimates a server utilization from the received service indicator. The apparatus determines the server utilization for one or more servers 105 and one or more clients 125 without adding an overhead burden to the servers 105 and/or the clients 125.

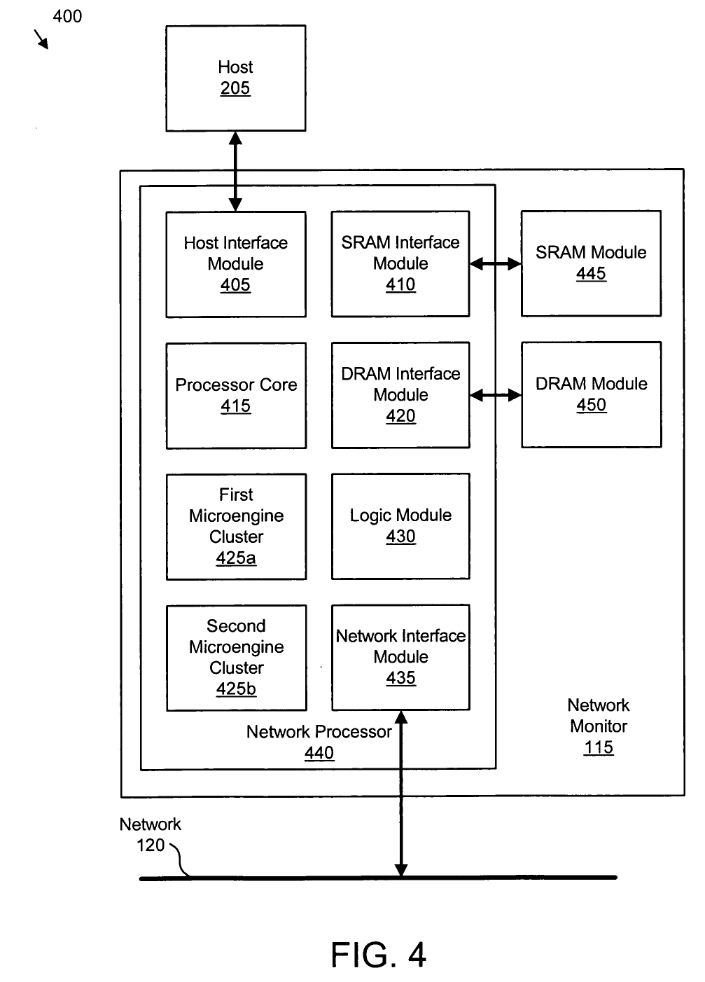

FIG. 4 is a schematic block diagram illustrating one embodiment of a network monitor 115 of the present invention. The network monitor 115 may be the network monitor 115 of FIGS. 1 and 2 and is shown in communication with the host 205 of FIG. 2 and the network 120 of FIGS. 1 and 2. The network monitor 115 includes a network processor 440, a static random access memory (“SRAM”) module 445, and a dynamic random access memory (“DRAM”) module 450.

The network processor 440 may be an Internet eXchange Architecture Network Processor such as the IXP2800 produced by Intel Corporation of Santa Clara, Calif. In addition, the network processor 440 may include a host interface module 405, SRAM interface module 410, processor core 415, DRAM interface module 420, one or more microengine clusters 425, logic module 430, and network interface module 435.

The host interface module 405, SAM interface module 410, processor core 415, DRAM interface module 420, microengine clusters 425, logic module 430, and network interface module 435 may be fabricated of semiconductor gates on a semiconductor substrate as is well known to those skilled in art. The host interface module 405 communicates with the host 205. In one embodiment, the host interface module 405 comprises a PCI interface.

The SRAM interface module 410 and DRAM interface module 420 communicate respectively with the SRAM module 445 and the DRAM module 450. The SRAM interface module 410 and DRAM interface module 420 may communicate with the SRAM module 445 and DRAM module 450 through semiconductor metal layers, substrate to substrate connections, or circuit card traces and/or wires connecting the semiconductor devices. In one embodiment, the SRAM module 445 includes quad data rate SRAM. The SRAM module 445 and DRAM module 450 may store instructions and/or data for the network processor 440 as is well known to those skilled in the art.

The processor core 415 executes instructions and processes data such as the instructions and data stored in the SRAM module 445 and/or DRAM module 450. In one embodiment, the processor core 415 executes one or more software processes comprising in whole or in part the monitor module 305, extraction module 310, and identification module 315 of FIG. 3.

Each microengine cluster 425 may include a plurality of microengines. For simplicity the microengines are depicted as microengine clusters 425. Each microengine may comprise memory registers, arithmetic logic, and control logic as is well know to those skilled in the art. One or more microengines may also execute in whole or in part the software processes comprising the monitor module 305, extraction module 310, and identification module 315.

The logic module 430 may include a plurality of semiconductor gates configured to perform one or more functions including data encryption and decryption, hardware address divides for computing hash table addresses, and the like. The network interface module 435 communicates with the network 120. In one embodiment, the network interface module 435 comprises an Ethernet interface.

In one embodiment, the communications module 325 comprises the host interface module 405. In addition, the communications module 325 may further comprise one or more software processes executing on the processor core 415 and/or one or more microengines. The communications module 325 may communicate the service indicator through the host interface module 405 to the host 205.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

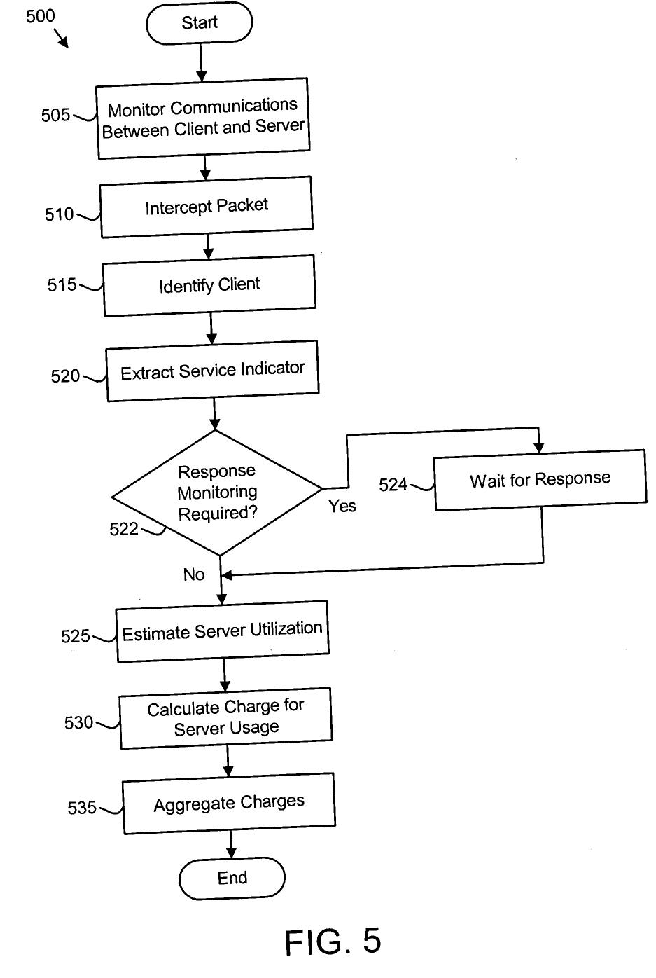

FIG. 5 is a schematic flow chart diagram illustrating one embodiment of a server utilization determination method 500 of the present invention. The method 500 substantially includes the steps to carry out the functions presented above with respect to the operation of the described apparatus 300, 400 and systems 100, 200 of FIGS. 1-4. In addition, the description of the method refers to elements of FIGS. 1-4, like numbers referring to like elements.

The method 500 begins and in one embodiment, the monitor module 305 may monitor 505 communications between the client 125 and the server 105. In one embodiment, the monitor module 305 employs the network interface module 435 to receive a plurality of packets communicated over the network 120. The network interface module 435 may receive the packets without affecting communications between the clients 125 and the server 105. In addition, the network interface module 435 may monitor 305 communications between a plurality of clients 125 and a plurality of servers 105.

The monitor module 305 further intercepts 510 a packet communicated between the client 125 and the server 105. In one embodiment, the network interface module 435 communicates the packet to one or more microengines in the first and/or second microengine cluster 425a, 425b. For example, the network interface module 435 may communicate the packet to a single microengine. Alternatively, the network interface module 435 may communicate portions of the packet to a plurality of microengines.

In one embodiment, the identification module 315 identifies 515 the client 125 from the packet. For example, the microengine receiving the packet may parse a source address and a destination address from the packet. The microengine may further calculate an identifier for a source corresponding to the source address and a destination corresponding to the destination address. In one embodiment, the identifier is the address. In a certain embodiment, the microengine further identifies the client using the identifier. For example, the microengine may use the identifier as a key to retrieve the identity of the client 125 from a data array that may be stored in the DRAM module 450. Alternatively, the microengine may communicate the identifier to the processor core 415 and the processor core 415 may retrieve the identity of the client 125 from the DRAM module 450 and/or the SRAM module 445.

The extraction module 310 extracts 520 the service indicator from the packet. In one embodiment, the microengine receiving the packet parses the packet to extract 520 the service indicator. For example, the receiving microengine may divide the packet into sub-strings and compare each sub-string against a template for one or more known service indicators as is well known to those skilled in the art. If a sub-string matches a template, the receiving microengine may extract 520 the service indicator by communicating the service indicator and/or corresponding template.

In one embodiment, the receiving microengine communicates the service indicator and/or template, herein referred to as the service indicator, to the processor core 415. The processor core 415 may format the service indicator in a message that is communicated through the host interface module 405 to the host 205. Alternatively the receiving microengine may communicate the service indicator to a microengine configured to format communications for the host 205. The formatting microengine may communicate the service indicator through the host interface module 405 to the host 205.

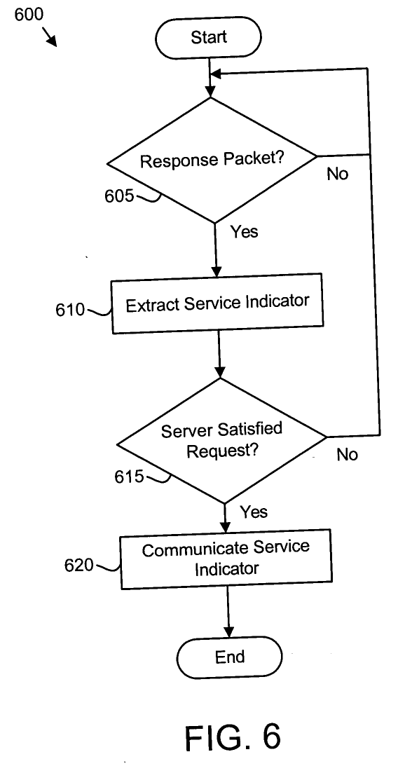

In one embodiment, the estimation module 320 determines 522 if response monitoring is required. The server response may be required in order to more accurately estimate the server utilization, necessitating monitoring for a transmission of the server response. If response monitoring is required, the identification module 315 waits 524 for the response as will be described hereafter in FIG. 6.

If the estimation module 320 determines 522 that response monitoring is not required, the estimation module 320 estimates 525 a server utilization based on the service indicator. The estimation module 320 may be embodied in the host 205. For example, the estimation module 320 may comprise one or more software processes executing on the host 205. In an alternate embodiment, the estimation module 320 may comprise one or more software processes executing on the network processor 440.

In one embodiment, the estimation module 320 employs the service indicator as a key to retrieve a server utilization estimate from a server utilization table as will be described hereafter. The table may include a plurality of service indicators and corresponding server utilization estimates. The estimation module 320 may match the extracted service indicator with a substantially equivalent service indicator from the table and retrieve the server utilization estimate corresponding to the matched table service indicator as will be illustrated hereafter.

The estimation module 320 may perform one or more calculations to estimate the server utilization. In one embodiment, the estimation module 320 identifies the server 105 and scales the usage in response to the identity of the server 105. For example, an administrator may assign each server 105 a scaling factor. The scaling factor may be related to the ability of each server 105 to complete computational tasks. Thus a faster server 105 may have a larger scaling factor than a slower server 105. Equation 1 shows the calculation of a final server utilization estimate e as the product of an initial server utilization estimate e₀ such as from the server utilization table and the scaling factor f. In one embodiment, e₀ is the estimated server utilization value retrieved from the server utilization table.
e=e₀f Equation 1

In one embodiment, the billing module 330 calculates 530 a charge for the server utilization. The billing module 330 may be embodied in the host 205. For example, the host 205 may execute one or more software processes comprising the billing module 330. Alternatively, the billing module 330 may be embodied in the network monitor 115.

In one embodiment, the billing module 330 calculates the charge c as the product of the server utilization estimate e and a fee rate r as shown in Equation 2.
c=ei Equation 2

The fee rate may be a standard rate for all times and/or all clients 125. Alternatively, each client 125 may have a unique fee rate. In addition, the fee rate may be derived from a fee schedule. The fee schedule may specify a first fee rate for a first time period and a second fee rate for a second time period.

In a certain embodiment, the billing module 330 aggregates 535 a plurality of charges and the method 500 terminates. In one example, the billing module 330 may aggregate the charges for a client 125. In addition, the billing module 330 may sum the server utilization estimates and the charges to produce a billing summary. In a certain embodiment, the billing module 330 aggregates the charges for a plurality of clients 125 associated with a customer.

Alternatively, the billing module 330 may aggregate 535 the charges for the server 105, a data center, or the like. In addition, the billing module 330 may aggregate 535 the server utilization estimates for the server 105 and/or data center. The billing module 330 may further communicate the aggregated charges to a transaction processing computer, a financial accounting program, or the like. The method 500 determines the server utilization estimate from intercepted communications between the server 105 and the client 125 without burdening the server 105 and/or client 105 with the overhead of estimating and recording the server utilization estimate.

FIG. 6 is a schematic flow chart diagram illustrating one embodiment of a response identification method 600 of the present invention. The method 600 substantially includes the steps to carry out the functions presented above with respect to the operation of the described method 500, apparatus 300, 400, and systems 100, 200 of FIGS. 1-5. In addition, the description of the method refers to elements of FIGS. 1-5, like numbers referring to like elements. In particular, the method 600 illustrates one embodiment of the “wait for response” step 524 of FIG. 5.

The method 600 begins and in one embodiment, the identification module 315 determines 605 if the intercepted packet of step 510 in FIG. 5 is a response from the server 105 to the client 125. A response from the server 105 may more accurately detail the services performed for the client 125 than a request from the client 125 to the server 105. If the identification module 315 determines 605 that the intercepted packet is not a response packet, the identification module 315 loops to determine 605 that the intercepted packet is the response packet.

If the identification module 315 determines 605 that the intercepted packet is a response packet, the extraction module 310 may extract 610 the service indicator from the intercepted packet such as is described for step 520 in FIG. 5. In one embodiment, the estimation module 320 determines 615 if the server 105 communicating the response satisfied a request of the client. If the estimation module 320 determines 615 that the server 105 did not satisfy the request, the identification module 315 may determine 605 if a subsequent intercepted packet is a response packet. For example, method 600 may terminate if the estimation module 320 determines 615 that a response from the server 105 to the client 125 indicates that a requested task is scheduled for execution but not complete.

If the estimation module 320 determines 615 from the response packet that the server 105 satisfied the request, the estimation module 320 may communicate 620 the service indicator and the method 600 terminates. For example, the estimation module 320 may communicate 620 the service indicator through the communication module 325 to the host 205. The method 600 identifies response packets that indicate the server 105 has satisfied a request, and communicates 620 the service indicator from such packets.

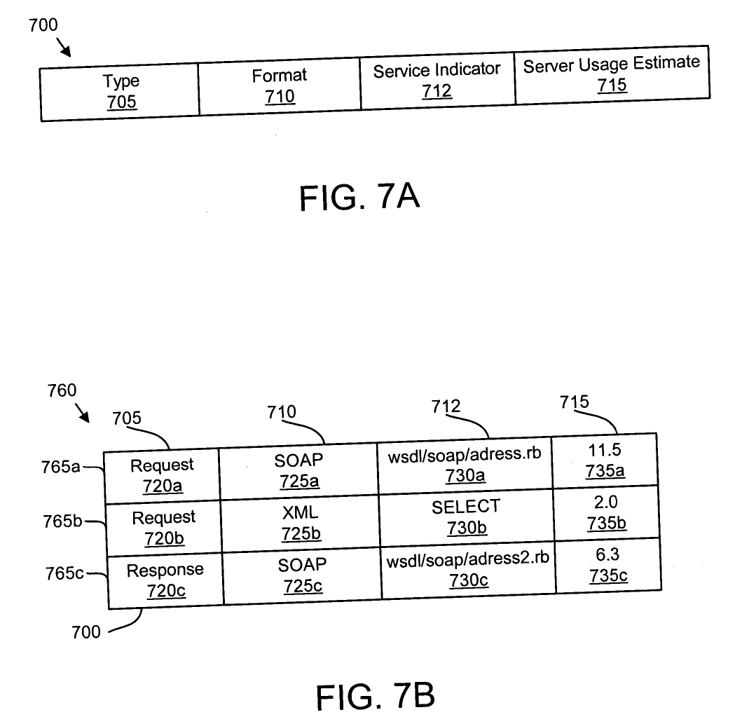

FIG. 7A is a schematic block diagram illustrating one embodiment of a server utilization table 700 of the present invention. The table 700 includes a type data field 705, format data field 710, service indicator data field 712, and server utilization estimate data field 715. The description of the table 700 refers to elements of FIGS. 1-6, like numbers referring to like elements.

The type data field 705 may store a value that indicates that the service indicator is embodied in a request packet from the client 125 to the server 105, herein referred to as request type. Alternatively, the type data field 705 may store a value that indicates that the service indicator is embodied in a response packet from the server 105 to the client 125, herein referred to as a response type.

The format data field 710 may store a value that indicates the format of the service indicator. For example, the value of the format data field 710 may specify that the service indicator is from an XML formatted packet, a SOAP formatted packet, or the like. The service indicator field 712 may store a service indicator. The estimation module 320 may estimate 525 the server utilization by matching an extracted service indicator with the service indicator stored in the service indicator field 712 as will be described hereafter.

The server utilization estimate data field 715 stores a server utilization estimate value corresponding to the service indicator of the service indicator stored in the service indicator data field 712. The server utilization estimate value may specify a server utilization such as milliseconds or seconds of usage.

FIG. 7B is a schematic block diagram illustrating one embodiment of server utilization table entries 760 of the present invention. The entries 760 are a prophetic example of entries to the server utilization table 700 of FIG. 7A. The description of the entries 760 refers to elements of FIGS. 1-7A, like numbers referring to like elements.

A plurality of rows 765 is depicted for the server utilization table 700. Each row 765 includes the type data field 705, format data field 710, service indicator data field 712, and server utilization estimate data field 715 of FIG. 7A. Each type data field 705 stores a type data value 720 such as a request type and/or a response type. In addition, each format data field 710 stores a format data value 725, each service indicator data field 712 stores a service indicator 730, and each server utilization estimate data field 715 stores a server utilization estimate 735.

The estimation module 320 may estimate 525 server utilization by matching an extracted service indicator as discussed in step 520 of FIG. 5 with a service indicator 730 of the table 700. For example, if the extracted service indicator is “wsdl/soap/address.rb,” the estimation module 320 may match the extracted service indicator with a first service indictor 730a from a first entry 765a of the table 700. In addition, the estimation module 320 may estimate 525 the server utilization as a first server utilization estimate 735a of the first entry 765a. In the depicted prophetic example, the estimation module 320 estimates 525 the server utilization as 11.5 seconds as specified by the first server utilization estimate 735a.

In one embodiment, the “Response” type data value 720c of the third entry 765c indicates that a server response should be used to estimate 525 server utilization. For example, the estimation module 320 may use the type data value 720 to determine if a response is required as described for step 522 of FIG. 5.

The embodiment of the present invention determines a server utilization by intercepting 510 a packet communicated between the client 125 and the server 105. In addition, the embodiment of the present invention determines the server utilization without affecting communications between the client 125 and the server 105, and without imposing an overhead burden on the server 105 and/or the client 125.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to determine server utilization, the apparatus comprising:
a monitor module configured to intercept a packet communicated between a client and a server;
an extraction module configured to extract a service indicator from the packet; and
an estimation module configured to estimate a server utilization based on the service indicator.

2. The apparatus of claim 1, the monitor module further configured to monitor communications between the client and the server.

3. The apparatus of claim 1, further comprising an identification module configured to identify the client from the packet.

4. The apparatus of claim 1, further comprising a communication module configured to communicate the server utilization to a host.

5. The apparatus of claim 1, wherein the intercepted packet is a response packet from the server to the client and the estimation module estimates the server utilization in response to the server satisfying a client request.

6. The apparatus of claim 1, wherein the service indicator is selected from a SOAP request and an XML service request name

7. A signal bearing medium tangibly embodying a program of machine-readable instructions executable by a digital processing apparatus to perform an operation to determine server utilization, the operation comprising:
intercepting a packet communicated between a client and a server;
extracting a service indicator from the packet; and
estimating a server utilization based on the service indicator.

8. The signal bearing medium of claim 7, wherein the instructions further comprise an operation to monitor communications between the client and the server.

9. The signal bearing medium of claim 8, wherein the instructions further comprise an operation to identify the client from the packet.

10. The signal bearing medium of claim 9, wherein the instructions further comprise an operation to communicate the server utilization to a host.

11. The signal bearing medium of claim 10, wherein the instructions further comprise an operation to calculate a charge for the server utilization.

12. The signal bearing medium of claim 11, wherein the instructions further comprise an operation to aggregate a plurality of charges.

13. The signal bearing medium of claim 7, wherein the intercepted packet is a response packet from the server to the client.

14. The signal bearing medium of claim 13, wherein the server utilization is estimated in response to the server satisfying a client request.

15. The signal bearing medium of claim 7, wherein the service indicator is a SOAP request.

16. The signal bearing medium of claim 7, wherein the service indicator is an XML service request name.

17. A system to determine server utilization, the system comprising:
a client;
a server;
a network configured to transmit communications between the client and the server;
a network monitor in communication with the network and comprising
a monitor module configured to monitor communications between the client and the server and intercept a packet communicated between the client and the server;
an extraction module configured to extract a service indicator from the packet; and
a host in communication with the network monitor and comprising
an estimation module configured to estimate a server utilization based on the service indicator; and
a billing module configured to calculate a charge for the server utilization and aggregate a plurality of charges.

18. The system of claim 17, the network monitor further comprising a communications module configured to communicate the service indicator to the host.

19. The system of claim 17, the network monitor further comprising an identification module configured to identify the client from the packet.

20. A method for deploying computer infrastructure, comprising integrating computer-readable code into a computing system, wherein the code in combination with the computing system is capable of performing the following:
monitoring communications between a client and a server;
intercepting a packet communicated between the client and the server;
identifying the client from the packet;
extracting a service indicator from the packet;
estimating a server utilization based on the service indicator; and
calculating a charge for the server utilization.
